(19) United States
(12) Patent Application Publication
(10) Pub. No.: US 2010/0171299 A1
(43) Pub. Date: Jul. 8, 2010

(54) ADDRESS BOOK

(76) Inventor: Rhonda Myers, Goodspring, TN (US)

Correspondence Address: LAW OFFICE OF JERRY D. HAYNES , P.A, P.O. Box 350392, Fort Lauderdale, FL, 33335, US

(21) Appl. No.: 12/348,341

(22) Filed: Jan. 5, 2009

(51) Int. Cl. B42D 1/00; B42D 3/00; B42D 5/00; B42F 21/00

(52) U.S. Cl. 281/27.1; 281/29; 281/38; 283/37

(57) ABSTRACT

Disclosed is an address book for storing and retrieving information related to one or more websites. The address book includes a plurality of address book leaves and a binding mechanism to removably secure the plurality of address book leaves together. Each of the plurality of address book leaves includes at least one information template configured thereon for storing the information related to the one or more websites.

### FIELD OF THE INVENTION

The present invention generally relates to address books, and, more particularly, to an address book for storing and retrieving information related to one or more websites.

### BACKGROUND OF THE INVENTION

An address book is a book or a database configured to store information related to a person, a firm and the like. For example, such information may include a name, a residential address, an office address, a telephone number, a mobile number and the like, of the person. The information may be stored in the address book in a way, such that, a user may be able to access, and accordingly, retrieve the information easily. Generally, the information stored in the address book may be required to be updated from time-to-time due to various reasons, such as change in address, change in telephone number, and the like. However, such an act of updating the information may require a user to utilize tools, such as erasers, whiteners and the like, for removing outdated information prior to adding new and updated information. However, use of such tools results in a cluttered representation of the information on the address book, thereby, imparting an untidy appearance to the address book. Further, most of such presently existing address books include address book leaves that are permanently affixed thereto, which leaves form a complete set altogether. Accordingly, it may become inconvenient for a user to shuffle the address book leaves as per his/her requirement for an easy reference.

Furthermore, use of the presently existing address books is associated with numerous other limitations. For example, the presently existing address books are incapable of effectively storing any other information apart from the information related to a person, a firm, and the like. More specifically, the presently existing address books are incapable of catering to the need of a user desiring to store information with regard to a specific website while browsing through internet web pages or while reading articles or magazines, in a systemic manner. Additionally, the user may encounter difficulties while retrieving the information stored within the presently existing address books due to the untidy and the cluttered appearance of the presently existing address books.

Accordingly, there exists a need for an address book that is capable of storing information related to one or more websites. Further, there is a need for an address book that is capable of easily retrieving information stored therewithin. Furthermore, there is a need for an address book that is capable of enabling a user to easily update information stored therewithin. Moreover, there is a need for an address book that is simple in construction and easy to use.

### SUMMARY OF THE INVENTION

In view of the foregoing disadvantages inherent in the prior art, the general purpose of the present invention is to provide an address book that is configured to include all the advantages of the prior art, and to overcome the drawbacks inherent therein.

Accordingly, an object of the present invention is to provide an address book that is capable of systematically storing information related to one or more websites.

Another object of the present invention is to provide an address book that is capable of easily retrieving information stored therewithin.

Yet another object of the present invention is to provide an address book that is capable of enabling a user to easily amend and update information stored therewithin.

Still another object of the present invention is to provide an address book that is simple in construction and easy to use.

In light of the above objects, an address book for storing and retrieving information related to one or more websites is disclosed. The address book includes a plurality of address book leaves and a binding mechanism configured to removably secure the plurality of address book leaves together. Each of the plurality of address book leaves comprises at least one information template configured thereon. The at least one information template is configured to store the information related to the one or more websites.

This aspect together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, in which:

FIG. 1 illustrates a perspective view of an address book, in accordance with an embodiment of the present invention; and

FIG. 2 illustrates a front view of an address book leave of plurality of address book leaves of the address book of FIG. 1, in accordance with an embodiment of the present invention.

Like reference numerals refer to like parts throughout the description of several views of the drawings.

### DETAILED DESCRIPTION OF THE INVENTION

The exemplary embodiments described herein detail for illustrative purposes are subject to many variations in structure and design. It should be emphasized, however, that the present invention is not limited to a particular address book, as shown and described. It is understood that various omissions and substitutions of equivalents are contemplated as circumstances may suggest or render expedient, but these are intended to cover the application or implementation without departing from the spirit or scope of the claims of the present invention.

The terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item.

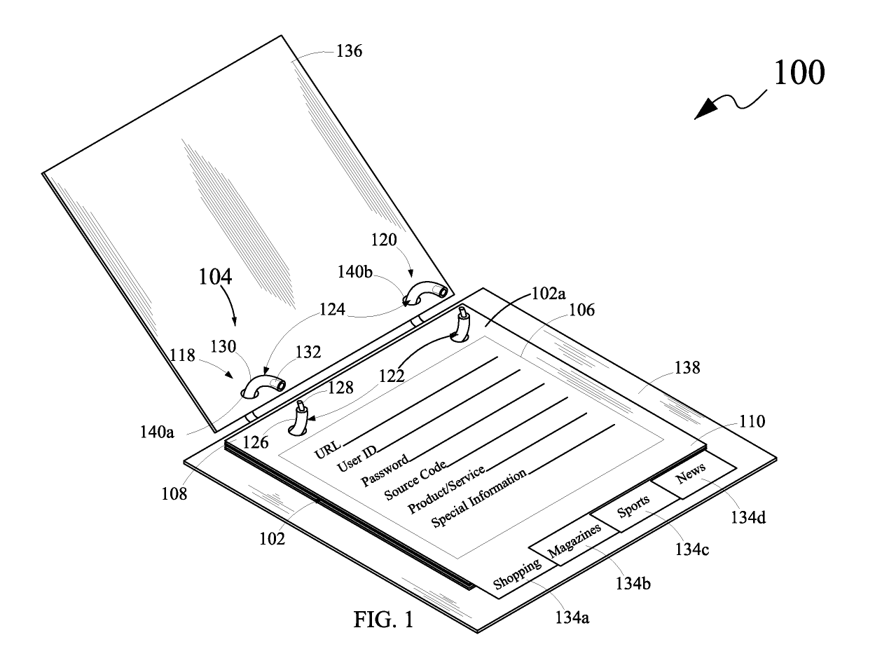

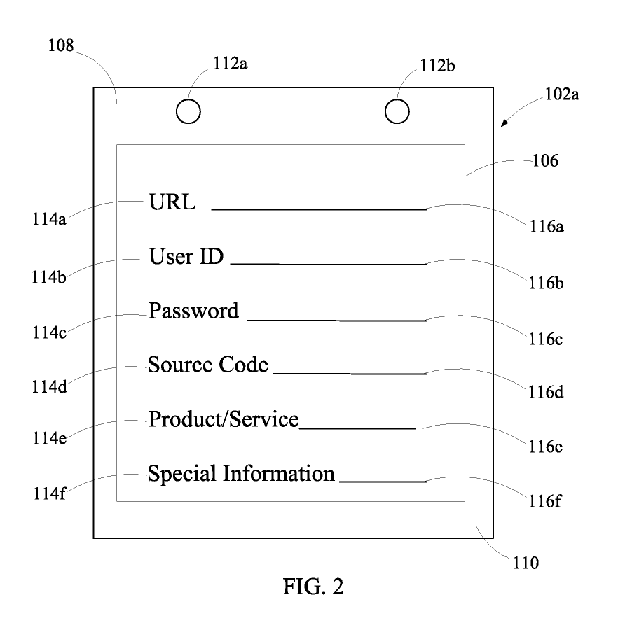

The present invention relates to an address book for storing and retrieving information related to one or more websites. The term “information” may refer to information related to any website and may include a Uniform Resource Locator (URL), a user identification, a password for accessing the website, and the like. The address book of the present invention is explained in detail in conjunction with FIGS. 1 and 2.

FIG. 1 illustrates a perspective view of an address book 100 that includes a plurality of address book leaves, such as an address book leave 102a (hereinafter collectively referred to as “plurality of address book leaves 102”), in accordance with an embodiment of the present invention. FIG. 2 illustrates a front view of the address book leave 102 of the plurality of address book leaves 102 of the address book 100 of FIG. 1. The address book 100 further includes a binding mechanism 104.

Each of the plurality of address book leaves 102 includes at least one information template, such as an information template 106; a first longitudinal edge portion 108; a second longitudinal edge portion 110; and a pair of apertures, such as an aperture 112a and an aperture 112b (hereinafter collectively referred to as “pair of apertures 112”) configured on the first longitudinal edge portion 108 (as shown in FIG. 2). The information template 106 is configured on the each of the plurality of address book leaves 102. Further, the information template 106 may be configured on the each of the plurality of address book leaves 102 as an information storage section and may be represented in a written form, a printed form or any other form known to a person having ordinary skill in the art. The information template 106 is configured to include information related to one or more websites. More specifically, the information template 106 is configured to be filled in using the information related to the one or more websites, and may be referred to by the user for retrieving the information, as and when desired. Although in the present embodiment of the present invention, the address book 100 is shown to include one information template, such as the information template 106, it should be understood that the address book 100 may include two or more than two information templates as per a user's requirement.

The at least one information template, such as the information template 106, includes at least one indicium. Each of the at least one indicium is one of a Uniform Resource Locator (URL) indicium, a user Identity (ID) indicium, a password indicium, a source code indicium, a product indicium, a service indicium and a special information indicium. For the purpose of this description and as shown in FIG. 2, the information template 106 includes a plurality of indicia, such as a Uniform Resource Locator (URL) indicium 114a (hereinafter referred to as “URL indicium 114a), a user identity (ID) indicium 114b (hereinafter referred to as “user ID indicium 114b), a password indicium 114c, a source code indicium 114d, a product/service indicium 114e, and a special information indicium 114f, configured thereon. The plurality of indicia may hereinafter collectively be referred to as “plurality of indicia 114”. Further, the plurality of indicia 114 may include any other indicia for storing other information related to the one or more websites as per the user's requirement. Furthermore, the plurality of indicia 114 may be configured on the information template 106 in a way such that the plurality of indicia 114 may be easily and conveniently read by the user.

More specifically, the plurality of indicia 114 may be configured in the form of text, for example “URL/Site”, “User ID”, “Password”, “Source code”, “Product/Service”, “Special information,” and the like. The text may be configured in written, printed or any other form known to a person having ordinary skill in the art. Alternately, the plurality of indicia 114 may also be configured in the form of various other letters, symbols, abbreviations, drawings and the like. Accordingly, the present invention is not limited to a specific type of indicium used. Although, in the present embodiment of the present invention, the information template 106 includes six types of indicia, such as the plurality of indicia 114, it should be apparent to a person skilled in the art that the information template 106 may include any number of indicia inquiring information related to the one or more websites, as per the user's requirement.

Furthermore, the information template 106 may include one or more designs and/or images for an aesthetic appearance. In one embodiment of the present invention, the information template 106 may include a plurality of horizontal extending lines, such as a horizontal extending line 116a, a horizontal extending line 116b, a horizontal extending line 116c, a horizontal extending line 116d, a horizontal extending line 116e, a horizontal extending line 116f (hereinafter collectively referred to as “plurality of horizontal extending lines 116”), which may be configured adjacent to the plurality of indicia 114 (as shown in FIG. 2). The plurality of horizontal extending lines 116 may be configured to provide a specific area located above the plurality of horizontal extending lines 116 which the user may utilize for writing information related to the one or more websites.

More specifically, the horizontal extending line 116a adjacent to the URL indicium 114a is configured to provide a space for writing a Uniform Resource Locator of a particular website. Similarly, the horizontal extending line 116b adjacent to the user ID indicium 114b is configured to provide a space for writing a user ID for the particular website. Further, the horizontal extending line 116c adjacent to the password indicium 114c is configured to provide a space for writing a password for the user ID of the particular website. Furthermore, the horizontal extending line 116d adjacent to the source code indicium 114d is configured to provide a space for writing a source code of the particular website. Still further, the horizontal extending line 116e adjacent to the product/service indicium 114e is configured to provide a space for writing a product or a service related to the particular website. Moreover the horizontal extending line 116f adjacent to the special information indicium 114f is configured to provide a space for writing any special information related to the particular website as per the user's requirement. Accordingly, the plurality of horizontal extending lines, such as the horizontal extending line 116a to the horizontal extending line 116f, is configured to provide a space for writing diverse information related to the particular website on the information template 106 of the plurality of address book leaves 102.

The plurality of address book leaves 102 is removably secured to each other by means of the binding mechanism 104. According to the present embodiment of the present invention, the binding mechanism 104 as shown in FIG. 1 is a ring binder mechanism (hereinafter referred to as “the binding mechanism 104”). The binding mechanism 104 includes a first ring 118, a second ring 120, and a spring-load mechanism (not shown). Each of the first ring 118 and the second ring 120 includes a first half ring portion 122 and a second half ring portion 124. The first half ring portion 122 includes a body portion 126 and a male locking portion 128 extending from the body portion 126. The second half ring portion 124 includes a body portion 130. The body portion 130 includes a female groove 132. The female groove 132 is configured on the body portion 130 of the second half ring portion 124 and is capable of receiving the male locking portion 128 of the first half ring portion 122. More specifically, the male locking portion 128 of the first half ring portion 122 is configured to be received in the female groove 132 of the body portion 130 of the second half ring portion 124 for locking the first half ring portion 122 to the second half ring portion 124.

The first half ring portion 122 and the second half ring portion 124 of the binding mechanism 104 are configured to assume one of a closed position and an open position. The closed position of the binding mechanism 104 is facilitated by the locking of the first half ring portion 122 to the second half ring portion 124. More specifically, the spring load mechanism is configured to exert a force on the first half ring portion 122 and the second half ring portion 124 to facilitate the locking of the first half ring portion 122 to the second half ring portion 124, thereby causing the binding mechanism 104 to attain the closed position.

Further, for configuring the open position of the binding mechanism 104, the user needs to move the first half ring portion 122 and the second half ring portion 124 away from each other in opposition to the force exerted by the spring load mechanism. In the open position of the binding mechanism 104, the user may add one or more leaves of the plurality of address book leaves 102 by receiving the pair of apertures 112 of the each of the plurality of address book leaves 102 in either the first half ring portion 122 or the second half ring portion 124 of the first ring 118 and the second ring 120. Similarly, in the open position of the binding mechanism 104, the user may remove one or more leaves of the plurality of address book leaves 102 by dispatching the pair of apertures 112 of the each of the plurality of address book leaves 102 from either the first half ring portion 122 or the second half ring portion 124 of the first ring 118 and the second ring 120, depending on an orientation of the each of the plurality of address book leaves 102.

Such a feature of the binding mechanism 104 provides an easy and quick mechanism that allows for a systematic storage of the information related to the one or more websites, for an easy retrieval of the stored information and for amendment of the stored information to keep a track of updated information regarding the one or more websites. For amending content of the address book 100, the binding mechanism 104 facilitates an easy removal and/or addition of the one or more leaves of the plurality of address book leaves 102. Further, with the help of the binding mechanism 104, leaves of the plurality of address book leaves 102 may be shuffled depending on the user's preference.

Although, in the present embodiment, the binding mechanism 104 is described as the ring binder mechanism. However, the binding mechanism 104 is not restricted to the ring binder mechanism. Further, the binding mechanism 104 may be any other binding mechanism, which is capable of removably securing a plurality of address book leaves, such as the plurality of address book leaves 102, together, and is known to a person having ordinary skill in the art. In an alternate embodiment of the present invention, the binding mechanism 104 may be a mechanism such as a coil binding mechanism, a spiral binding mechanism and a three-ring binding mechanism.

Further, in one embodiment of the present invention, the address book 100 includes a plurality of tabs, such as a first tab 134a, a second tab 134b, a third tab 134c and a fourth tab 134d (hereinafter collectively referred to as “plurality of tabs 134”), to catalog the plurality of address book leaves 102 as per the user requirement. Each of the plurality of tabs 134 is disposed on the second longitudinal edge portion 110 of a few leaves of the plurality of address book leaves 102. The fewer leaves of the plurality of address book leaves 102 may be selected as per the user's preference. Accordingly, the plurality of tabs 134 facilitates easy retrieval of the information stored in the address book 100. Each of the plurality of tabs 134 may be labeled with categories such as “Shopping,” “Magazines,” “Sports” and “News” and the like, as per the user requirement (as shown in FIG. 1). More specifically, a particular leaf of the plurality of address book leaves 102 may include a tab of the plurality of tabs 134 labeled with a particular category, such as “Shopping.” Accordingly, leaves of the plurality of address book leaves 102 that include information of websites belonging to the “Shopping” category may follow the particular leave, thereby, forming a set of leaves under the “Shopping” category. In one embodiment of the present invention, the plurality of tabs 134 may be labeled with alphabets, symbols and any other such representation for an easy identification of the categories.

Still further, the address book 100 may include a front cover 136 and a back cover 138 secured to the plurality of address book leaves 102 by means of the binding mechanism 104. More particularly, the front cover 136 includes a pair of apertures, such as an aperture 140a and an aperture 140b (hereinafter collectively referred to as “pair of apertures 140”) configured thereon. Similarly, the back cover 138 includes a pair of apertures (not shown), similar to the pair of apertures 140. Accordingly, the front cover 136 and the back cover 138 are secured to the plurality of address book leaves 102 by means of the binding mechanism 104 and the pair of apertures of the front cover 136 and the back cover 138. The front cover 136 and the back cover 138 are employed to configure the plurality of address book leaves 102 therebetween. Further, in one embodiment of the present invention, the front cover 136 may be labeled with an indicium, such as “E-DDRESS BOOK,” (not shown) on an outer surface (not shown) thereof, for indicating type of the information contained in the address book 100. The front cover 136 and the back cover 138 may be composed of cardboard, plastic, tweeds, faux leathers, cottons, silk and the like.

Various embodiments of the present invention offer the following advantages. The address book, such as the address book 100, as described herein, is capable of enabling a user to easily store, retrieve and/or amend information stored therewithin, where such information is related to various websites. Further, the address book is simple in construction and easy to use. Furthermore, the address book serves as a portable organizer for storing information related to the various websites, in a categorized manner. Use of the address book enables a user to keep up-to-date and organized information about the various websites.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The embodiments were chosen and described in order to best explain the principles of the present invention and its practical application, and to thereby enable others skilled in the art to best utilize the present invention and various embodiments with various modifications as are suited to the particular use contemplated. It is understood that various omissions and substitutions of equivalents are contemplated as circumstances may suggest or render expedient, but such omissions and substitutions are intended to cover the application or implementation without departing from the spirit or scope of the claims of the present invention.

1. An address book for storing and retrieving information related to one or more websites, the address book comprising:
a plurality of address book leaves, each of the plurality of address book leaves comprising at least one information template configured thereon for storing the information related to the one or more websites; and
a binding mechanism comprising a first ring and a second ring, each of the first ring and the second ring comprising
a first half ring portion having a male locking portion, and
a second half ring portion having a female groove configured to receive the male locking portion, to removably secure the plurality of address book leaves together.

2. The address book of claim 1, wherein the at least one information template comprises at least one indicium.

3. The address book of claim 2, wherein each of the at least one indicium is one of a Uniform Resource Locator (URL) indicium, a user Identity (ID) indicium, a password indicium, a source code indicium, a product indicium, a service indicium and a special information indicium.

4. The address book of claim 1, wherein the binding mechanism is a ring binding mechanism.

5. The address book of claim 1, further comprising a plurality of tabs disposed on leaves of the plurality of address book leaves to catalog the plurality of address book leaves.

6. The address book of claim 1, further comprising a front cover and a back cover secured to the plurality of address book leaves by means of the binding mechanism, such that, the front cover and the back cover configure the plurality of address book leaves therebetween.
